(19) United States
(12) Patent Application Publication
(10) Pub. No.: US 2025/0366481 A1
(43) Pub. Date: Dec. 4, 2025

(54) ANT BAIT MATERIAL AND EXTRACTION METHOD THEREOF

(71) Applicant: National Changhua University of Education, Changhua County (TW)

(72) Inventor: CHUNG-CHI LIN, Changhua County (TW)

(21) Appl. No.: 18/733,437

(22) Filed: Jun. 4, 2024

(51) Int. Cl. A01N 65/08; A01N 37/44; A01N 43/16; A01P 19/00

(52) U.S. Cl. CPC A01N 65/08; A01N 37/44; A01N 43/16; A01P 19/00

(57) ABSTRACT

An ant bait material includes 0.1 wt % to 0.3 wt % of a tea leaf extract, 7.5 wt % to 13.5 wt % of an attractant, and 86.2 wt % to 92.4 wt % of water. The present invention uses the tea leaf extract as an active ingredient in the ant bait, which is more environmentally and human and animal-friendly due to its natural composition. Also, the ant bait exhibits a shorter time of action.

### BACKGROUND OF THE INVENTION

### 1. Field of the Invention

The present invention relates to an ant bait material and its material extraction method, and more particularly, to an ant bait material which applies tea leaf extract as an active ingredient and its material extraction method.

### 2. Description of the Related Art

Ants problem has become increasingly severe in recent years. For example, the population of Dolichoderus thoracicus has surged in the central and southern regions of Taiwan, not only severely impacting the lives of residents, but also causing issues in crop harvesting. In the coastal areas of southern Taiwan, Anoplolepis gracilipes also pose a threat to the population of land crabs.

Although there are many ants controlling products on the market, conventional pesticides usually require a longer action duration, potentially causing a risk of poisoning if accidentally ingested by children or pets.

Therefore, the improvement of conventional ant baits is desirable.

### SUMMARY OF THE INVENTION

To improves the issues above, the present invention discloses an ant bait material which applies tea leaf extract as an active ingredient and its material extraction method.

For achieving the aforementioned objectives, the present invention provides an ant bait material, comprising a tea leaf extract, an attractant, and water. Therein, the ant bait material includes 0.1 wt % to 0.3 wt % of the tea leaf extract, 7.5 wt % to 13.5 wt % of the attractant, and 86.2 wt % to 92.4 wt % of water. The weight percentage of each ingredient is calculated based on the overall weight of the ant bait material.

In an embodiment, the present invention provides an extraction method of an ant bait material, comprising following steps: mixing 5 wt % to 10 wt % of a tea leaf and 70 wt % to 85 wt % of an ethanol to form a first mixture solution and boiling the first mixture solution in an airtight condition; heating the first mixture solution by atmospheric distillation to obtain a concentrated liquid extract; adding 5 wt % to 20 wt % of a calcium oxide into the liquid extract to form a second mixture solution; heating the second mixture solution at low temperature until complete evaporation of a solvent in the second mixture solution to obtain a residual mixture, and grinding the mixture into a powder; and purifying the mixture by atmospheric sublimation to obtain a tea leaf extract.

Accordingly, the present invention applies the tea leaf extract obtained from natural tea leaves as an active ingredient for ants extermination. Therefore, the present invention lowers environmental pollution compared with chemical pesticides. Moreover, the active ingredient in tea leaf extract efficiently kills ants with a shorter action duration, so as to effectively restrain ants populations.

### BRIEF DESCRIPTION OF THE DRAWINGS

FIG. 1 is a structural block view of the ant bait material in accordance with an embodiment of the present invention.

FIG. 2 is a flow chart of the extraction method of the ant bait material in accordance with an embodiment of the present invention.

FIG. 3 is a schematic view illustrating the efficacy test result of the ant bait material of the present invention applied on Dolichoderus thoracicus.

FIG. 4 is a schematic view illustrating the efficacy test result of the ant bait material of the present invention applied on Anoplolepis gracilipes.

### DETAILED DESCRIPTION OF THE INVENTION

The aforementioned and further advantages and features of the present invention will be understood by reference to the description of the preferred embodiment in conjunction with the accompanying drawings.

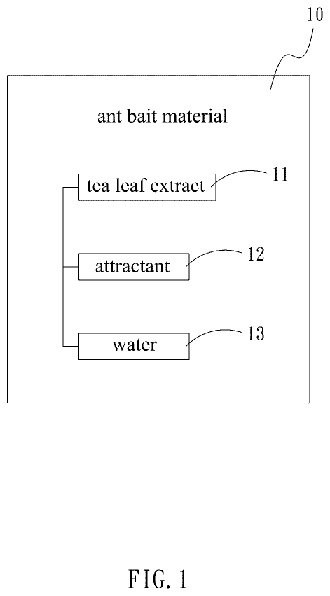

Referring to FIG. 1, the present invention provides an ant bait material 10, comprising a tea leaf extract 11, an attractant 12, and water 13. Therein, the ant bait material 10 includes 0.1 wt % to 0.3 wt % of the tea leaf extract 11, 7.5 wt % to 13.5 wt % of the attractant 12, and 86.2 wt % to 92.4 wt % of water 13. The weight percentage of each ingredient is calculated based on the overall weight of the ant bait material 10.

Therein, the preferred weight percentage ratio among the tea leaf extract 11, the attractant 12, and the water 13 is 0.5%:10.5%:89%.

Therein, the attractant 12 is Monosodium glutamate (MSG) or sucrose.

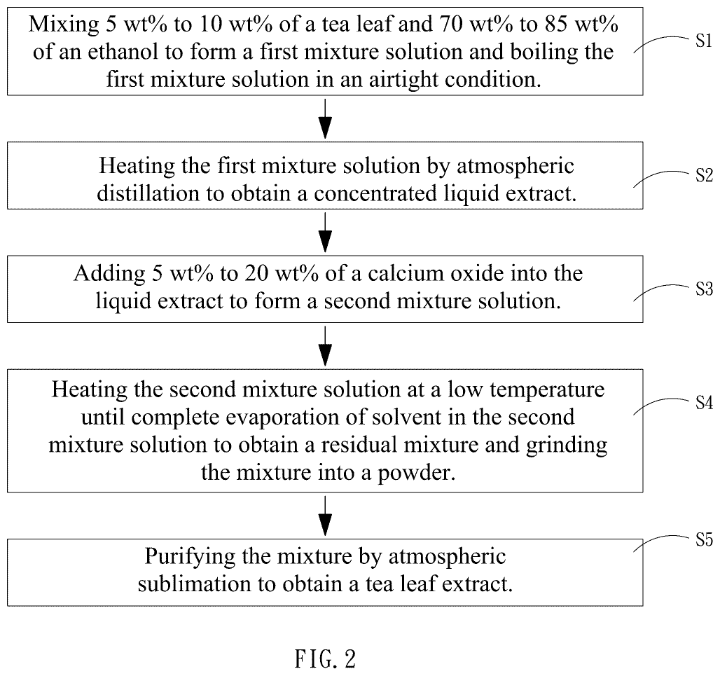

Referring to FIG. 2, in an embodiment of the present invention, an extraction method of the ant bait material 10 is provided, comprising following steps S1 to S5.

In the step S1, 5 wt % to 10 wt % of a tea leaf and 70 wt % to 85 wt % of an ethanol are mixed to form a first mixture solution, and the first mixture solution is boiled in an airtight condition.

In the step S2, the first mixture solution is heated by atmospheric distillation to obtain a concentrated liquid extract. The concentration volume of the liquid extract is one-sixth (⅙) to one-fourth (¼) of the volume of the added ethanol. In other words, for 100 ml of ethanol, the concentration volume of the liquid extract is 16 ml to 25 ml. The heating temperature of the atmospheric distillation ranges from 70 degrees Celsius to 135 degrees Celsius.

In the step S3, the liquid extract is added with 5 wt % to 20 wt % of a calcium oxide to form a second mixture solution.

In the step S4, the second mixture solution is heated at a low temperature until a solvent in the second mixture solution is completely evaporated, so as to obtain a residual mixture; then, the mixture is ground into a powder. The low temperature ranges from 55 degrees Celsius to 67 degrees Celsius.

In the step S5, the mixture is further purified by atmospheric sublimation to obtain the tea leaf extract 11.

An embodiment of the invention is described as follows.

### [Tea Leaf Extract 11 Preparation Process]

Materials: 10 g of tea leaves, 100 ml of ethanol, 6 g of calcium oxide

Equipment: Soxhlet extractor, reflux condensing device (using Allihn condenser), atmospheric sublimation device, evaporating dish, long-stem funnel, glassware, cotton gauze, filter paper, cling film, electric heating device.

### Steps:

Ethanol reflux extraction: 10 g of tea leaves are placed in a 250 ml round-bottom flask, and 100 ml of ethanol is added thereinto. After installing the reflux condensing device and ensuring the airtightness, the mixture is heated to boiling for 40 minutes. The airtightness is examined by dripping distilled water onto the interface of the glassware using a dropper. When no obvious gas is observed, the airtightness is ensured. Atmospheric distillation concentration: The refluxed liquid extract is filtered and heated for concentrating the liquid extract to 20 ml. Therein, the heating temperature for the liquid extract above ranges from 70 degrees Celsius to 135 degrees Celsius and is allowed to be 70, 73, 75, 77, 80, 83, 85, 87, 90, 93, 95, 97, 100, 103, 105, 107, 110, 113, 115, 117, 120, 123, 125, 127, 130, 133, or 135 degrees Celsius.

Acid-base neutralization extraction: The concentrated liquid is poured into a ceramic evaporating dish, and then 6 g of calcium oxide is added.

Tea leaf powder preparation: The neutralized extract is placed on a heating plate and heated at a low temperature. In the experiment, the heating temperature is 60 degrees Celsius. After the solvent is completely evaporated, the extract is ground into a powdery extract using a mortar and pestle. Therein, the low temperature ranges from 55 degrees Celsius to 67 degrees Celsius and is allowed to be 55, 56, 57, 58, 59, 60, 61, 62, 63, 64, 65, 66, or 67 degrees Celsius.

Atmospheric sublimation: Due to impurities in the substance after ethanol evaporation, a further purification is required by use of atmospheric sublimation and temperature variations for carrying further separation and purification, so as to convert the solid state thereof into the gas state. The ground solid powder is evenly laid on the evaporating dish, and the evaporating dish is covered with a filter paper which is pierced with many bores. Finally, the evaporating dish is covered with a short-stem funnel, with a small amount of cotton wool is stuffed at an end thereof. The temperature shall be maintained between approximately 115 degrees Celsius and 200 degrees Celsius. Next, allow the to-be-extracted substance to undergo the desublimation upon cooling, thereby refining the tea leaf extract 11. Therein, the temperature is allowed to be maintained at 115, 120, 125, 130, 135, 140, 145, 150, 155, 160, 165, 170, 175, 180, 185, 190, 195, or 200 degrees Celsius.

### [Bait Experiment]

Experiment 1: Dolichoderus thoracicus

Each ant colony for the test includes 100 worker ants and 3 queens. The ant colony is housed in an artificial terrarium and starved for three days. Approximately 5 grams of the novel bait of the present invention (containing 0.5 wt % of the tea leaf extract 11, 10.5 wt % of the attractant 12, and 89 wt % of water 13) are placed in the terrarium for the ant colony of an experimental group to feed on freely during the experiment (n=3). Ant colony of a control group is provided with approximately 5 grams of non-toxic artificial feed (n=3).

Starting the day after the bait/artificial feed is placed, the survival status of the worker ants and the queens are observed. Dead individuals are counted and removed daily until all worker ants and queens in the experimental group are deceased, at which point the observation is stopped. An average cumulative mortality rate is calculated at the end of the experiment.

Experiment 2: Anoplolepis gracilipes

Each ant colony for the test includes 150 worker ants and 1 queen. The ant colony is housed in the artificial terrarium and starved for three days. The method and recording procedures for the bait efficacy test are the same as those for Dolichoderus thoracicus.

### Test Results:

Worker ants (both Dolichoderus thoracicus and Anoplolepis gracilipes) started experiencing convulsions after consuming the novel bait of the present invention, and then succumbed to poisoning in a short period of time.

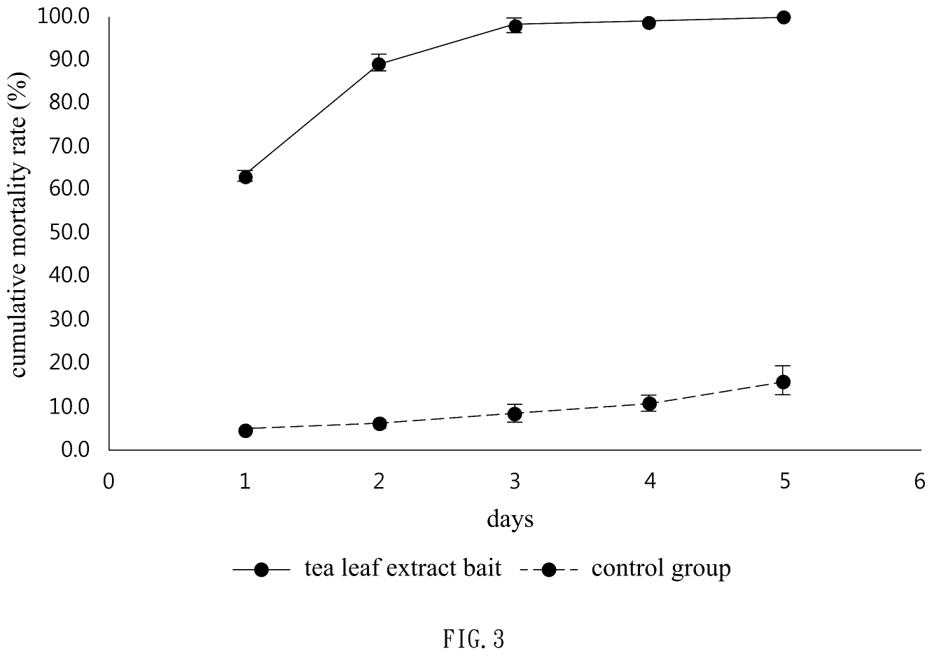

Referring to FIG. 3, regarding the Dolichoderus thoracicus, in the experimental group, the worker ants reached a median lethality after one day of ingesting the ant bait of the present invention, with an average cumulative mortality rate of approximately 63.3%. The median lethal time (LT50) for worker ants was 0.82 days (Probit analysis), and nearly all worker ants were dead after three days. Since the first day of the experiment, there was already a significant difference in the average cumulative mortality rate between the experimental group and the control group (t-test, P<0.001).

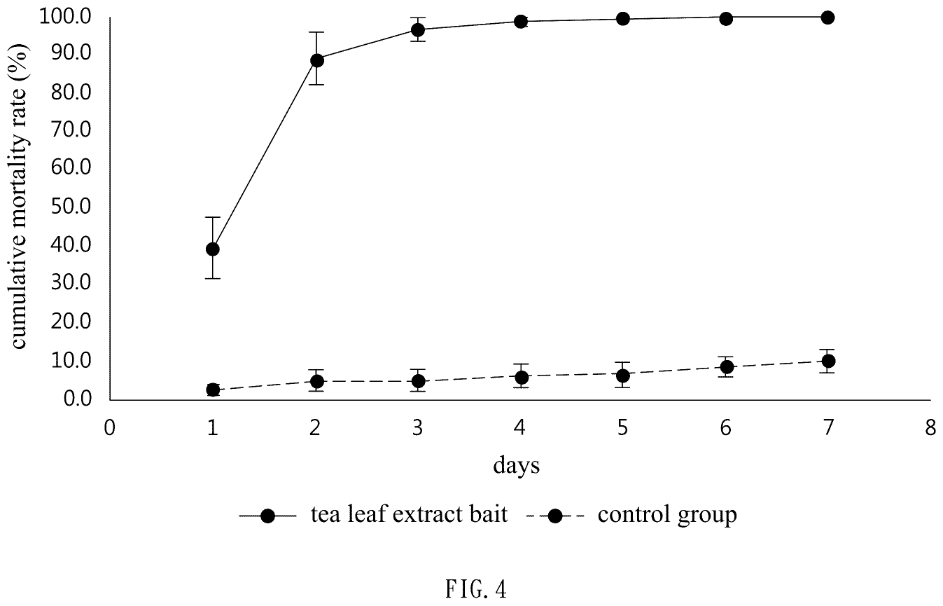

Referring to FIG. 4, regarding the Anoplolepis gracilipes, in the experimental group, the worker ants reached a median lethality after two days of ingesting the ant bait of the present invention, with an average cumulative mortality rate of approximately 89.9%. The median lethal time (LT50) for worker ants was 1.12 days (Probit analysis), and nearly all worker ants were dead after three days. Since the first day of the experiment, there was already a significant difference in the average cumulative mortality rate between the experimental group and the control group (t-test, P<0.001).

Regarding both Dolichoderus thoracicus and Anoplolepis gracilipes, the queens in the experimental groups were all dead in 7 days.

### Conclusion of the Experiment:

The novel ant bait containing the tea leaf extract 11 as the active ingredient shows a significant lethality against both Dolichoderus thoracicus and Anoplolepis gracilipes. The worker ants ingesting the ant bait succumb to poisoning rapidly. Also, through the trophallaxis behavior, the worker ants bring the ant bait back to the nest, achieving a colony-wide extermination. The ant bait material 10 of the present invention is also applicable to other ant species that prefer liquid food feeding in the future.

With such configuration, the present invention achieves following advantages.

The present invention achieves a highly effective poisoning. Through the active ingredients in the tea leaf extract 11, the present invention efficiently poisons and kills ants, thereby effectively controlling the ants population.

The present invention is environmentally friendly. The tea leaf extract 11 of the present invention is an extract obtained from natural plants, which is prevented from causing pollution or hazard to soil, water source, or other creatures during the usage, so as to be environmentally friendly.

Cost of the present invention is relatively low. Being a natural resource, tea leaves are easily obtained, so that the manufacturing cost of the tea leaf extract 11 preparation is lower.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. An ant bait material, comprising:
0.1 wt % to 0.3 wt % of a tea leaf extract;
7.5 wt % to 13.5 wt % of an attractant; and
86.2 wt % to 92.4 wt % of a water;
wherein the weight percentage of each ingredient is calculated based on an overall weight of the ant bait material.

2. The ant bait material of claim 1, wherein a preferred weight percentage ratio among the tea leaf extract, the attractant, and the water is 0.5%:10.5%:89%.

3. The ant bait material of claim 1, wherein the attractant is selected from a group consisting of Monosodium glutamate (MSG) and sucrose.

4. An method for extracting the ant bait material of claim 1, comprising following steps:
A. mixing 5 wt % to 10 wt % of a tea leaf and 70 wt % to 85 wt % of an ethanol to form a first mixture solution and boiling the first mixture solution in an airtight condition;
B. heating the first mixture solution by atmospheric distillation to obtain a concentrated liquid extract;
C. adding 5 wt % to 20 wt % of a calcium oxide into the liquid extract to form a second mixture solution;
D. heating the second mixture solution at a low temperature until complete evaporation of a solvent in the second mixture solution to obtain a residual mixture; and
E. purifying the mixture by atmospheric sublimation to obtain the tea leaf extract.

5. The method of claim 4, wherein after obtaining the mixture, the mixture is ground into a powder.

6. The method of claim 5, wherein a concentration volume of the liquid extract is one-sixth to one-fourth of a volume of the added ethanol.

7. The method of claim 6, wherein a heating temperature of the atmospheric distillation ranges from 70 degrees Celsius to 135 degrees Celsius.

8. The method of claim 6, wherein a heating temperature of the low temperature heating ranges from 55 degrees Celsius to 67 degrees Celsius.

9. The method of claim 6, wherein a preferred heating temperature of the low temperature heating is 60 degrees Celsius.

10. The method of claim 6, wherein a temperature of the atmospheric sublimation is controlled between 115 degrees Celsius and 200 degrees Celsius.
